(19) United States
(12) Patent Application Publication
(10) Pub. No.: US 2008/0006485 A1
(43) Pub. Date: Jan. 10, 2008

(54) ELEVATOR INSTALLATION AND METHOD OF OPERATING AN ELEVATOR INSTALLATION

(76) Inventors: Hans Kocher, Udligenswil (CH); Miroslav Kostka, Ballwil (CH)

Correspondence Address: FRASER CLEMENS MARTIN & MILLER LLC, 28366 KENSINGTON LANE, PERRYSBURG, OH, 43551, US

(21) Appl. No.: 11/764,891

(22) Filed: Jun. 19, 2007

(30) Foreign Application Priority Data
Jun. 19, 2006 (EP) 06115627.9

(51) Int. Cl. B66B 1/18

(52) U.S. Cl. 187/382

(57) ABSTRACT

An elevator installation and a method of operating the elevator installation with a shaft, in which at least a first elevator car and second elevator car are separately movable upwardly and downwardly for serving destination calls includes a control device, which determines a suitable one of the elevator cars for serving the destination calls. The first elevator car is moved either synchronously in time with the second elevator car, or displaced in time relative to the second elevator car, in dependence on at least one operating parameter, but still within the time duration of a journey of the second elevator car.

### FIELD OF THE INVENTION

The present invention relates to an elevator installation and to a method of operating an elevator installation with a shaft, in which at least one first elevator car and second elevator car are separately movable upwardly and downwardly for serving destination calls. In addition, a control device which determines a suitable elevator car for serving the destination calls is provided.

### BACKGROUND OF THE INVENTION

In order to convey a multiplicity of persons within the shortest possible time by means of an elevator installation in, in particular, business or office buildings so-termed double-floor elevators are known in which two cars directly above one another and fixedly connected together always move simultaneously to two adjacent floors.

Thus, a method of controlling an elevator installation with a multiple car having an upper deck and a lower deck is known from publication EP 1 193 207 A1, in which two floors can be served simultaneously by one stop. Allocation of a travel request from a start floor to a destination floor of a car deck takes place shortly before reaching the start floor. A travel request can also be re-allocated until shortly before reaching the start floor or allocated to the other deck. The allocation of the travel request is carried out in dependence on general criteria and/or in dependence on allocated travel requests for the region of the start floor and/or in dependence on travel requests for the region of the destination floor.

Moreover, elevator installations for the transport of a multiplicity of persons within a short time are known in which at least two elevator cars can move upwardly and/or downwardly independently of one another in a common shaft.

With respect to this, a method of controlling an elevator installation with at least one shaft and several elevator cars is known from publication WO 2004/048243 A1, wherein at least two elevator cars are separately movable upwardly and downwardly along a common travel path. After a passenger has placed a destination call, an allocation evaluation is carried out for each elevator car, subsequently the allocation evaluations of all elevator cars are compared with one another and finally the destination call, in order to be served, is assigned to the elevator car with the best allocation evaluation. As soon as the destination call has been assigned to the elevator car, the travel path section, which is required for serving the destination call, of the shaft is blocked, for the time of performance of the trip for serving the destination call, to the other elevator cars movable along the common travel path. If serving the destination call requires a journey over a plurality of floors a comparatively large travel path section is thus blocked to all remaining elevator cars, whereby a significant restriction of transport capacity occurs particularly in high-rise buildings with many floors.

### SUMMARY OF THE INVENTION

In the case of the present invention, an elevator installation and a method of operation are provided wherein a first elevator car is moved, in dependence on at least one operating parameter, either synchronously in time with a second elevator car or displaced in time relative to the second elevator car, but still within the time duration of a journey of the second elevator car.

There are understood by “operating parameter” in the sense of the present invention all factors which influence utilization of the elevator installation with respect to an already past use, the instantaneous use and a future use. Preferably, this dependence refers to only one operating parameter. The operating parameter can, in the case of need, also change in the course of the operating duration of the elevator installation.

In preferred embodiments of the elevator according to the present invention the operating parameter is oriented towards the transportation or traffic amount, i.e., for example, the number of destination calls issued by the users or the number of persons or articles to be conveyed. In this connection the transportation amount is preferably determined by the number of issued destination calls. Alternatively or additionally the transportation amount can be determined by the number of persons or articles to be conveyed. The number of issued destination calls can be detected in simple manner by the control device. Equally, the number of persons to be conveyed can be ascertained in simple manner by means of at least one detecting device, such as, for example, a sensor or a light barrier, which can then transmit the ascertained data to the control device. Such a detection device can be provided in, for example, the access region of a passenger elevator or loading region of a freight or goods elevator.

A higher transport capacity is thus achieved, since movement of the elevator cars simultaneously for at least a time is made possible particularly also for the case that the travel paths for the first and second elevator cars embrace a common travel path section. This leads to an increase in performance capability of the elevator installation and can be used for both oppositely directed and identically directed travel directions of the elevator cars.

It is thus made possible to form, for example, a virtual pair from the individual elevator cars movable upwardly and/or downwardly separately from one another, wherein the respective individual cars forming one pair can lie closely one above the other or, however, far apart. In addition, virtual elevator car groups can be formed from more than two individual elevator cars. Moreover, the method according to the present invention makes it possible for two elevator cars to be able to be moved simultaneously over a longer path in the same travel direction or also in opposite travel directions.

In a further advantageous development it is provided that the first and second travel car are mechanically coupled by way of a coupling in the case of movement synchronously or displaced in time. In this manner there is formed, during the movement synchronously or displaced in time, a temporary double-decker in which the small distance from one to the other elevator car does not have to be checked by way of further, special collision avoidance means such as sensors, controls, etc. Beyond that it is advantageous that the distance of the coupling from one to the other elevator car is settable so that compensation can be provided for different floor heights.

The present invention can be used in passenger elevators, freight elevators and goods elevators.

Advantageously the first and second elevator cars are moved synchronously or displaced in time from a predetermined limit value of the operating parameter. This first limit value can, for example, be fixed by means of values established in advance or fixed and changed on the basis of operating data continuously ascertained during the operating period of the elevator installation, for example by means of average values over specific time periods. Moreover, the limit value can be calculated to be at different levels for different times of the day, for example in peak times at the beginning and end of a working day and depending on the respective day of the week.

In a further advantageous embodiment, from a predetermined further limit value of the operating parameter the first and second elevator cars are no longer moved synchronously or displaced in time. Advantageously, the lower limit value lies at a lower transportation incidence than the first limit value.

The advantage of this switching-on and switching-off of the movement of the elevator car synchronously or displaced in time resides in the fact that, in the case of low traffic, destination calls can be allocated to individual elevator cars not moving synchronously or displaced in time and that, in the case of dense traffic, a collective operation with elevator cars moving synchronously or displaced in time takes place.

In addition, the operating parameter can also be established by means of the ratio of the orientations of the travel directions of the first and second elevator cars. Thus, the first elevator car and the second elevator car can, for example, be moved synchronously in time relative to one another if both elevator cars were allocated, by the control device, the same travel direction for providing the elevator car at the start floor or for serving the respective destination call from the start floor. In addition, a movement of first and second elevator cars displaced in time can be provided when one of the elevator cars has to cover a comparatively short travel path by comparison with the other elevator car in order to serve the respective destination call. The advantage thus results that an elevator car can, even before the journey of the other elevator car has ended, be set into motion and thus it is not necessary to wait until the journey thereof is completely concluded.

In a further advantageous embodiment the operating parameter can be determined by a travel path section of the shaft. In this connection a specific travel path section, for example between two predetermined floors, or the length of the travel path section, can be used as a decisive factor.

In an advantageous development it is provided that the first travel car or the second travel car is moved in an empty state. Thus, the travel paths which have to be overcome for serving a destination call can be kept free in critical cases. In addition, elevator cars moved displaced in time can, through travel of at least one elevator car in empty state, be moved again synchronously with one another at the latest on the occasion of the next journey. The position of the obstructing elevator car and the positions of the destination floors of the destination calls can be utilized to determine the length and direction of the travel in empty state.

Advantageously the destination call is delivered to the control device by means of a destination call panel, a destination call terminal or a mobile communications unit, such as, for example, a mobile telephone.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic vertical section view through an elevator installation for performance of the method according to the present invention; and

FIGS. 2 to 6 are similar to FIG. 1 and show variations of the method of operation of the elevator installation.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

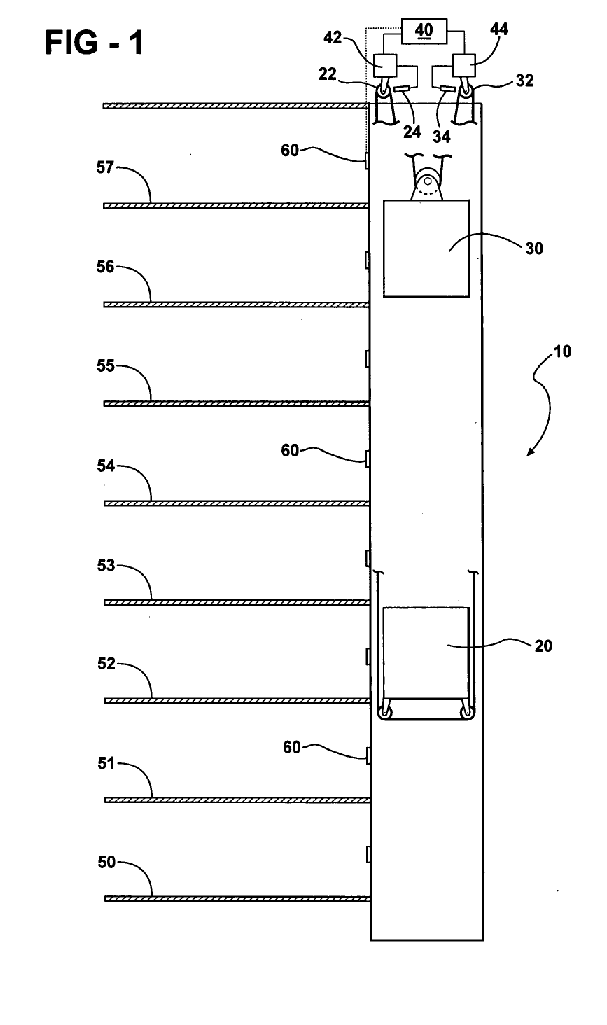

FIG. 1 schematically shows an elevator installation in the form of a passenger elevator for a commercial building. The elevator installation comprises a shaft 10 in which a first elevator car 20 and a second elevator car 30 are separately movable upwardly and/or downwardly. In addition, the building has eight floors 50 to 57, which can be reached via the elevator installation by persons located in the building. Disposed on each of these floors 50 to 57 at the outer side of the shaft wall is a destination call panel 60 which makes it possible for the user to issue a destination call with the desired destination floor.

The elevator installation according to FIG. 1 is a drive-pulley elevator installation, wherein the first elevator car 20 is moved and braked by means of, respectively, a drive unit 22 and a brake unit 24. Equally, the second elevator car 30 is moved and braked by means of, respectively, a drive unit 32 and a brake unit 34. The support cables or support belts and counterweights required for operation are constructed in a conventional manner and, just as the shaft and car doors as well as further operating and display elements, for the sake of simplicity are either not illustrated or are shown schematically.

A first control unit 42 is connected with the drive unit 22 and the brake unit 24. A second control unit 44 is connected with the drive unit 32 and the brake unit 34. In addition, a control device 40 is provided, which stands in data exchange communication with the first control unit 42 and the second control unit 44 as well as with all of the destination call panels 60 of the individual floors 50 to 57.

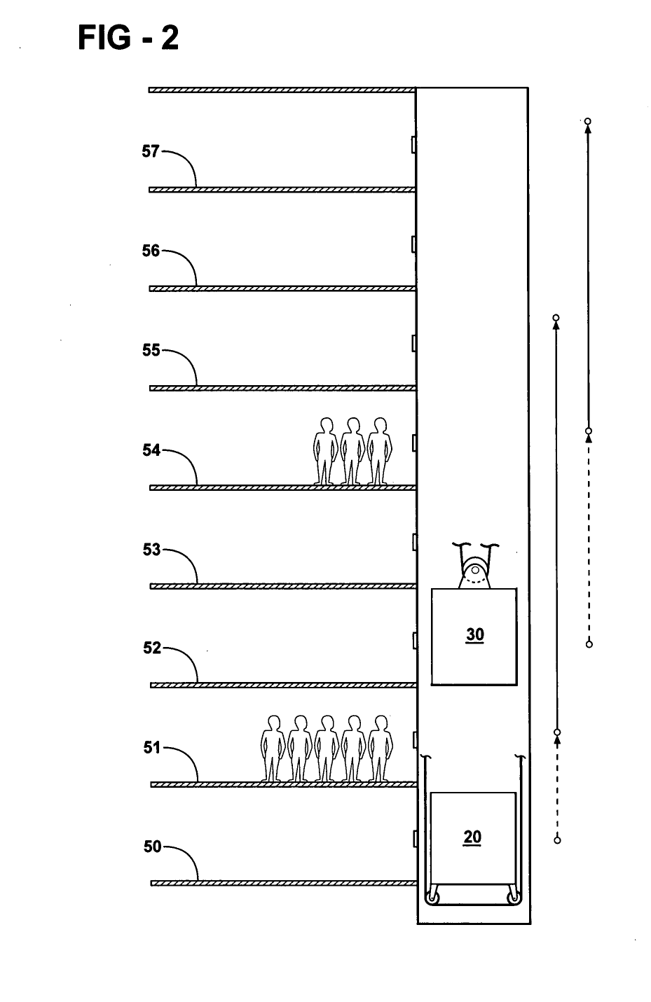

Several variants of the method according to the present invention for operating this elevator installation are explained in the following by way of FIGS. 2 to 6 on the basis of the elevator installation according to FIG. 1. In that case so-termed reporting journeys, i.e. journeys of an elevator car from the illustrated start setting to the start floor are shown in dashed lines. The serving journeys from the start floor to the destination floor for serving the destination calls are shown by solid lines. For safe embarking and disembarking of persons the car floors of the elevator cars 20, 30 are, at the stop of the elevator cars 20, 30 at each of the floors 50 to 57, aligned to be substantially flush with the floor floors of the respective floors 50 to 57.

In the starting situation shown in FIG. 2 a number of persons is located on the second floor 51 and these persons wish to be conveyed to the sixth floor 55 and have issued the corresponding travel request, which is termed a first destination call in the following, to the control device 40 by way of the destination call panel 60. In addition, several persons wishing to be conveyed to the eighth floor 57 are located on the fifth floor 54. This travel request shall here represent a second destination call. The first elevator car 20 is located on the first floor 50 and the second elevator car 30 is located at the level of the third floor 52.

After the control device 40 has determined the first travel car 20 to be the suitable travel car for serving the first destination call and the second travel car 30 to be the suitable travel car for serving the second destination call the first travel car 20 and the second travel car 30 are moved, starting from the initial situation according to FIG. 2, synchronously in time in the direction of the two start floors 51, 54 on which the persons to be conveyed are located. In other words, the two travel cars 20, 30 are set in motion at substantially the same point in time.

After the first travel car has arrived at the second floor 51, the shaft car doors open so that the persons on the second floor 51 can enter the car of the first elevator car 20. At the same time the persons on the fifth floor 54 can, after arrival of the second elevator car 30, enter the car thereof.

Subsequently the first elevator car 20 travels from the start floor 51 to the desired destination floor 55, whilst the second elevator car 30 is moved from the start floor 54 to the destination floor 57. The first elevator car 20 reaches its start floor 51 first due to the shorter travel path. The first elevator car 20 can therefore also begin its serving journey at an earlier point in time than the second elevator car 30. The serving journeys of the two elevator cars 20, 30 thus do not, in fact, start at the same point in time, but nevertheless run simultaneously at least for a time, so that here reference can be made to a movement of the two elevator cars 20, 30 displaced in time. In the case of reporting journeys of the elevator cars 20, 30 to the respective start floors 51, 54 there is, thereagainst, travel synchronous in time.

In the example of embodiment according to FIG. 2 the serving journeys of the two elevator cars 20, 30 embrace a common travel path section along the floors 54, 55. In addition, the two elevator cars 20, 30 have the same travel direction not only during the reporting journeys, but also during the serving journeys.

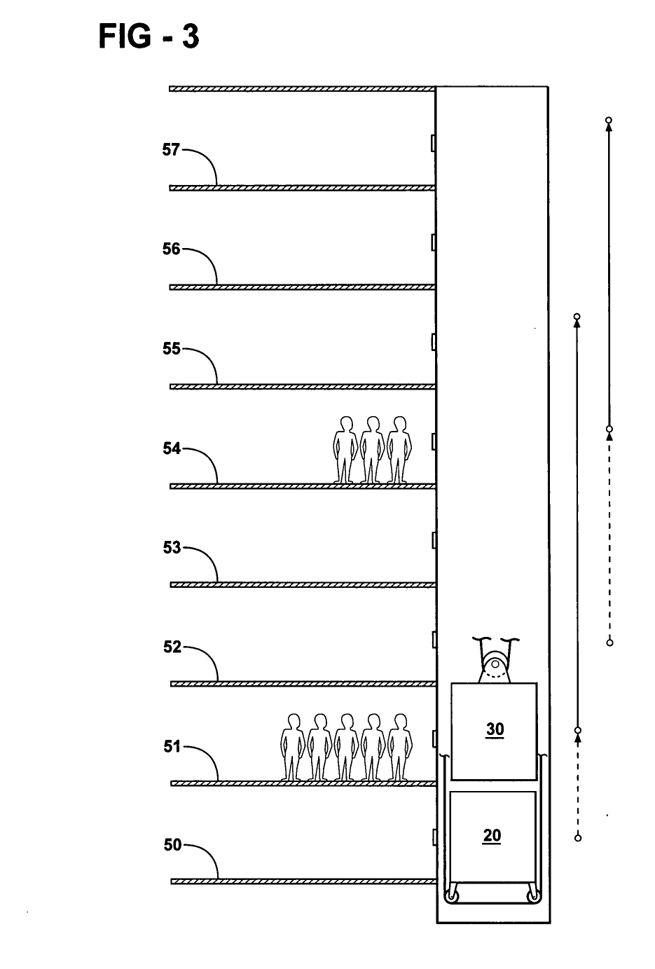

The example of embodiment according to FIG. 3 differs from the example of embodiment according to FIG. 2 in that the second elevator car 30 is initially positioned at the second floor 51. Starting from this situation initially the second elevator car 30 is moved in the direction of the start floor 54. As soon as the second elevator car 30 is located in the region of the third floor 52, the first elevator car 20 is moved from the first floor 50 to the start floor 51. The first elevator car 20 is thus set in motion displaced in time relative to the second elevator car 30. After the two elevator cars 20, 30 have reached their respective start floor 51 or 54, the serving journeys are undertaken correspondingly to the above example of embodiment according to FIG. 2.

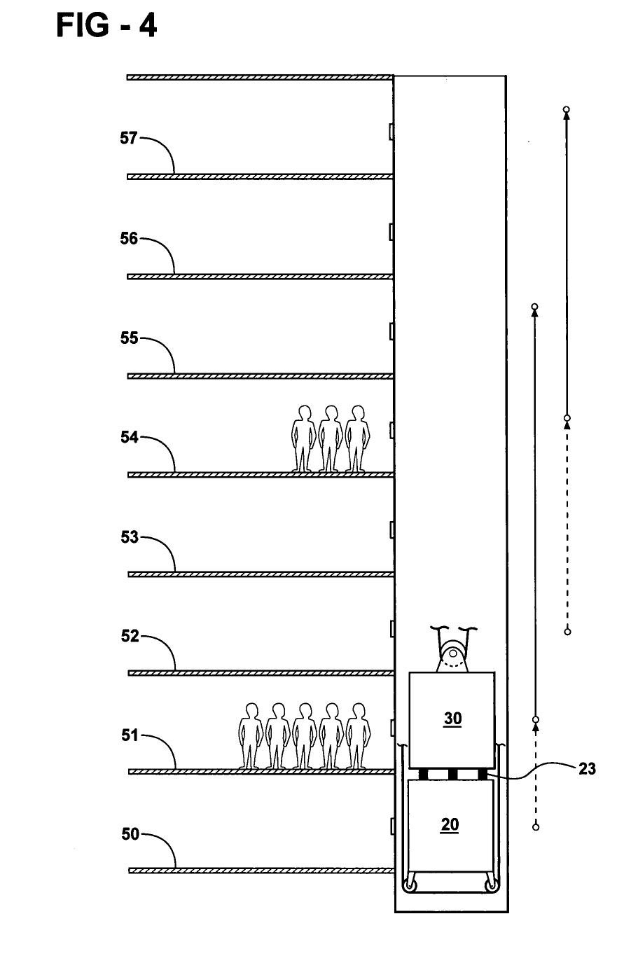

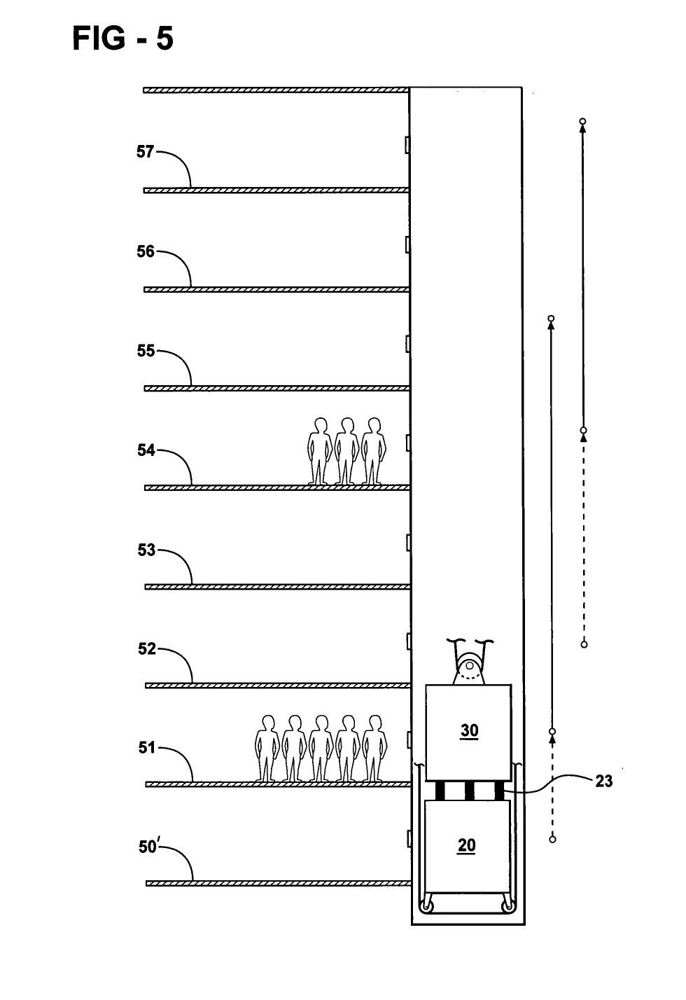

The examples of embodiment according to FIGS. 4 and 5 differ from the example of embodiment according to FIG. 3 in that the first elevator car 20 and the second elevator car 30 are mechanically coupled by way of a coupling 23 in the case of movement synchronously or displaced in time. Such a coupling 23 enables coupling together and decoupling and can be realized by mechanically positive coupling means known to the expert, such as a detent coupling, but also by way of force-locking means such as a magnetic coupling, etc. The coupling together or decoupling advantageously takes place automatically on approach or movement apart of the elevator cars 20, 30. In addition, the coupling 23 can be provided with or without security against undesired decoupling. With knowledge of the present invention the expert can realize numerous variants of such a coupling.

Beyond that it is advantageous for the distance of the coupling 23 from one to the other elevator car 20, 30 to be settable so that compensation can be provided for different floor heights. Thus, the example of embodiment according to FIG. 5 shows a hotel with a lobby in the lower floor 50′, which is higher than the upper floors 51 to 57 with identical floor heights. The example of embodiment according to FIG. 4 shows an office building in which all the floors 50 to 57 are of identical height. The travel cars 20, 30 are positioned in the floors 50 or 50′ and 51 and coupled by way of the coupling 23. The car floors are aligned to be flush with the floor floors. Comparison of the examples of embodiment according to FIGS. 4 and 5 shows that the distance of the coupling 23 of the elevator cars 20, 30 is so set that compensation is provided for the height difference between the lobby 50′ and the other floors 51 by enlargement of the distance of the coupling. Such a setting of the distance of the coupling 23 can be realized in simple and quick manner by the expert with known means such as a spindle drive, a pantograph, etc. Here, too, the expert can, with knowledge of the present invention, realize numerous variants of such a setting of the distance of the coupling.

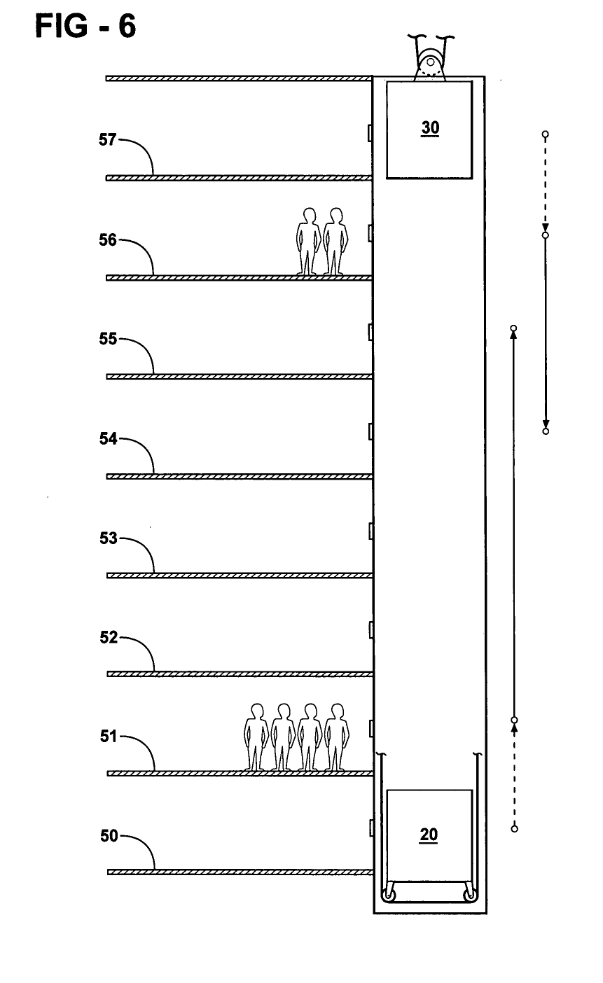

In the initial situation, which is shown in FIG. 6, of a further example of embodiment of the method several persons are again located on the second floor 51, these persons wishing to be conveyed to the sixth floor 55 and having delivered the corresponding travel request, which here shall be termed first destination call, to the control device 40 by way of the destination call panel 60. In addition, several persons wishing to be conveyed to the fifth floor 55 are located on the seventh floor 56. This travel wish shall here represent the second destination call. In addition, the first elevator car is located at the first floor 50, whereagainst the second elevator car 30 stands at the eighth floor 57.

After the control device has determined the first elevator car 20 to be the suitable elevator car for serving the first destination call and the second elevator car 30 to be the suitable elevator car for serving the second destination call, the first elevator car 20 and the second elevator car 30 are moved, starting from the initial situation, synchronously in time in the direction of the two start floors 51 and 56, respectively, i.e. the two elevator cars 20, 30 are set in motion at substantially the same point in time.

After the first elevator car 20 has arrived at the start floor 51 the persons on the second floor 51 can enter the car of the first elevator car 20. After arrival of the second elevator car 30 at the start floor 56 the persons on the seventh floor 56 can enter the car thereof. Due to the simultaneous instant of starting and the same travel path up to the respective start floor 51, 56 the two elevator cars 20, 30 arrive at the start floors 51, 56 approximately simultaneously.

The second elevator car 30 now initially travels from the start floor 56 in the direction of the desired destination floor 54 in order to execute the serving journey for serving the first destination call. At a spacing in time therefrom, thus displaced in time, but still during the travel duration of the serving journey of the second elevator car 30, the first travel car 20 starts from the start floor 51 in the direction of the destination floor 55. The displacement in time is selected in such a manner that sufficient time is present in order to move the second elevator car 30, after transport of the persons to the fifth floor 54, immediately again in upward direction and at least to the seventh floor 56. The first elevator car 20 can thus then move to the destination floor 55 of the second destination call without obstruction.

The reporting journeys of the elevator cars 20, 30 thus begin at substantially the same point in time, i.e. synchronously in time, whereas the elevator cars 20, 30 are moved displaced in time relative to one another in the subsequent serving journeys. In the example of embodiment according to FIG. 6 the two travel cars 20, 30 have mutually opposite travel directions not only during the reporting journeys, but also during the serving journeys.

The afore-described examples of embodiment of the method according to FIGS. 2 to 6 are distinguished particularly by the fact that especially in the case of a number of persons to be conveyed, i.e. in the case of a high incidence of transport, the two travel cars 20, 30 are moved either synchronously in time or displaced in time relative to one another. The selection of the mode of movement is carried out by means of the control device 40 and suitable algorithms. In this manner, for example, it is possible to dispense with keeping a travel path section, which is common to both elevator cars 20, 30, free for only one travel car and completely blocking the section to the other travel car until conclusion of the respective serving journey. An increase in transport capacity can thus be achieved in simple manner.

It shall be noted that the method, which for the sake of simplicity was explained only by means of two travel cars, for operating the elevator installation can also be performed with more than two travel cars.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method of operating an elevator installation with a shaft in which at least a first elevator car and a second elevator car are separately movable upwardly and downwardly for serving destination calls and with a control device, which determines a suitable elevator car for serving the destination calls, comprising the steps of: moving the first elevator car either synchronously in time with the second elevator car, or displaced in time relative to the second elevator car, in dependence on at least one operating parameter, but still within a time duration of a journey of the second elevator car.

2. The method according to claim 1 wherein the at least one operating parameter is determined by the transportation amount.

3. The method according to claim 2 wherein the transportation amount is determined by a number of issued destination calls.

4. The method according to claim 2 wherein the transportation amount is determined by a number of persons or objects to be conveyed.

5. The method according to claim 1 wherein based upon a predetermined limit value of the at least one operating parameter the first elevator car and the second elevator car are moved synchronously or displaced in time.

6. The method according to claim 5 wherein based upon a further predetermined limit value of the at least one operating parameter the first elevator car and the second elevator car are no longer moved synchronously or displaced in time.

7. The method according to claim 1 wherein the at least one operating parameter is determined by a ratio of orientations of travel directions of the first elevator car and the second elevator car.

8. The method according to claim 1 wherein the at least one operating parameter is determined by a travel path section of the shaft.

9. The method according to claim 1 wherein the first elevator car and the second elevator car are mechanically coupled by a coupling during movement synchronously or displaced in time.

10. The method according to claim 9 wherein a distance of the coupling from the first elevator car to the second elevator car is set in order to compensate for different floor heights.

11. The method according to claim 1 wherein the first elevator car or the second elevator car is moved in an empty state.

12. The method according to claim 1 wherein the destination calls are delivered to the control device by a destination call panel, a destination call terminal or a mobile communications unit.

13. An elevator installation with a shaft in which at least a first elevator car and a second elevator car are separately movable upwardly and downwardly for serving destination calls and with a control device, which determines a suitable elevator car for serving the destination calls, comprising: the control device moving the first elevator car either synchronously in time with the second elevator car, or displaced in time relative to the second elevator car, in dependence on at least one operating parameter, but within a time duration of a journey of the second elevator car.

14. The elevator installation according to claim 13 including a coupling for connecting the first elevator car with the second elevator car during at least a portion of the journey of the second elevator car.
